(19) United States
(12) Patent Application Publication
(10) Pub. No.: US 2016/0124210 A1
(43) Pub. Date: May 5, 2016

(54) Apparatus For Viewing Celestial Objects

(71) Applicant: E&B Giftware, LLC, Elmsford, NY (US)

(72) Inventors: Paul Howard Ross, Pound Ridge, NY (US); Scott Rubenstein, Ridgewood, NJ (US)

(21) Appl. No.: 14/879,195

(22) Filed: Oct. 9, 2015

Related U.S. Application Data
(60) Provisional application No. 62/062,009, filed on Oct. 9, 2014.

(51) Int. Cl. G02B 23/16; H04M 1/04; G02B 23/18

(52) U.S. Cl. CPC G02B 23/16; G02B 23/18; H04M 1/04

(57) ABSTRACT

Embodiments are directed to an apparatus incorporating a smart phone and a celestial viewing device. A mounting device includes a bracket that is capable of holding a smart phone on a telescope or a pair of binoculars. This serves to support a user in viewing celestial objects in the sky, when the smart phone is running an application that assists the user in locating the celestial objects. The apparatus advantageously provides for finding stars, planets, constellations, satellites, and the like. The apparatus allows for the user to manipulate the celestial viewing device without being concerned about or inconvenienced by the placement or handling of the smart phone. Additionally, the apparatus positions the smart phone in an orientation necessary to synchronize information shown on the smart phone with the field of view of the celestial viewing device, greatly improving the user's ability to locate and view desired celestial objects.

### CROSS-REFERENCE TO RELATED APPLICATIONS

This application claims priority to U.S. Provisional Patent Application No. 62/062,009, filed Oct. 9, 2014 and entitled “Apparatus for Viewing Celestial Objects,” the contents of which are hereby incorporated by reference in their entirety.

### TECHNOLOGY FIELD

The present invention relates generally to devices for viewing celestial objects, and more particularly to a mounting device for mounting a smart phone or device on a celestial viewing device to aid in the viewing of celestial objects.

### BACKGROUND

Users of celestial viewing devices, such as telescopes and binoculars, may wish to have more guidance on locating and identifying various celestial objects. An application installed and running on a smart phone, or other smart device, may assist in this area, but separately handling a smart phone and the viewing device is cumbersome and inconvenient. Thus, an apparatus to incorporate a smart phone and a celestial viewing device is desired.

### SUMMARY

Embodiments of the present invention provide for a mounting device to support a smart phone, or other smart device, on a telescope or a pair of binoculars to assist a user in viewing celestial objects in the sky. The smart phone may be, according to an embodiment, running an installed application that assists the user in finding the celestial objects. Embodiments provide for the synchronization of information from the smart phone, directing the user where to locate the targeted celestial object with the position of the hardware's field of view.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIGS. 1A-1D illustrate a mounting device for mounting and securing a smart phone to a pair of binoculars, according to an embodiment;

FIGS. 2A-2E illustrate an apparatus used for viewing celestial objects, according to embodiments provided herein;

FIGS. 3A-3B illustrate a mounting device for mounting and securing a smart phone to a telescope, according to an additional embodiment; and

FIGS. 4A-4D illustrate an apparatus used for viewing celestial objects, according to an additional embodiment provided herein.

### DETAILED DESCRIPTION

Embodiments relate to an apparatus used to view celestial objects in the sky. Embodiments relate to a mounting device that holds a smart phone, or other smart device, on a telescope or a pair of binoculars to support a user in viewing celestial objects in the sky, when the smart phone is running an installed application that assists the user in locating the celestial objects. While embodiments herein are described with reference to a smart phone, the embodiments are not so limited, and in fact, any app-enabled “smart” device, such as a tablet or the like, may be used.

The apparatus advantageously provides for a convenient way to find stars, planets, constellations, satellites, and the like with the use of a celestial viewing application installed on a smartphone that is mounted to a telescope, a pair of binoculars, or the like. With the celestial viewing application running, the apparatus allows for a user to locate and view various celestial objects. Moreover, the apparatus provides for the user to manipulate the celestial viewing device (e.g., a telescope or a pair of binoculars) without being concerned about or inconvenienced by the placement or handling of the smart phone. Additionally, the apparatus positions the smart phone in an orientation necessary to synchronize the information shown on the smart phone with the telescope's or binoculars' field of view, greatly improving the user's ability to locate and view desired celestial objects. In some preferred embodiments, the mounting device aligns the smartphone and hardware together as one unit so that as a user rotates and tilts the binoculars or telescope, the field of view of the binoculars or telescope focuses on the image/information shown on the screen of the smart phone.

Detailed aspects are provided below with reference to the various figures.

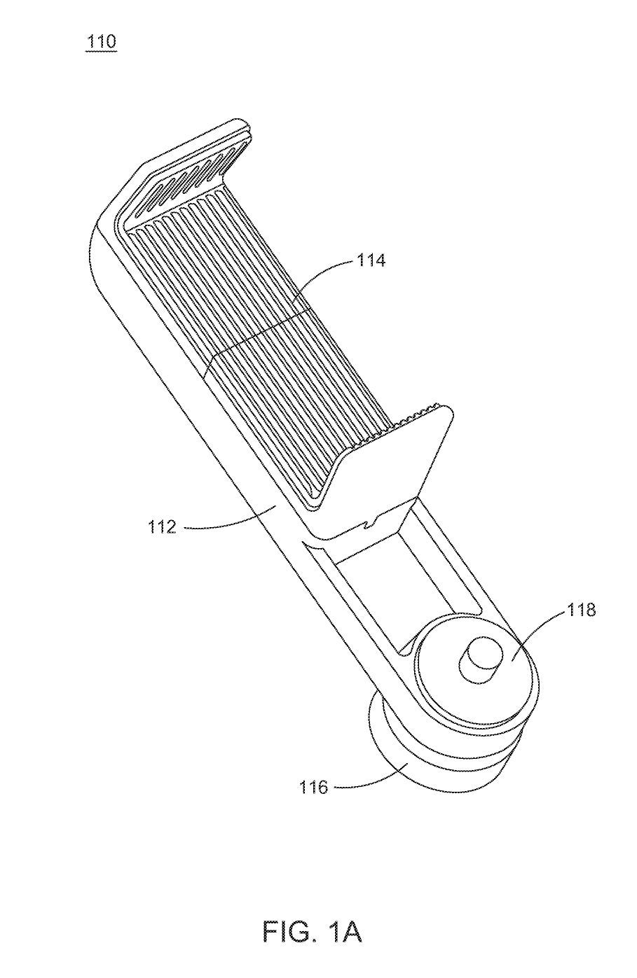

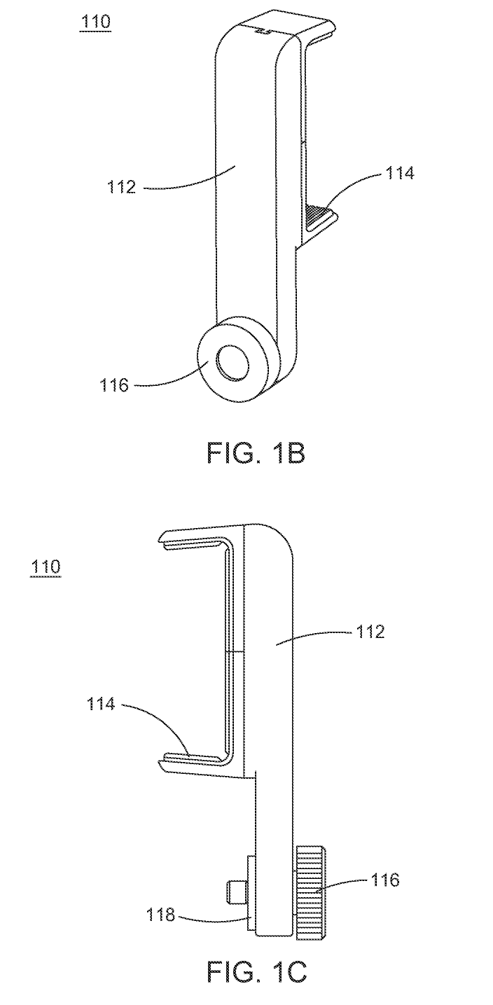

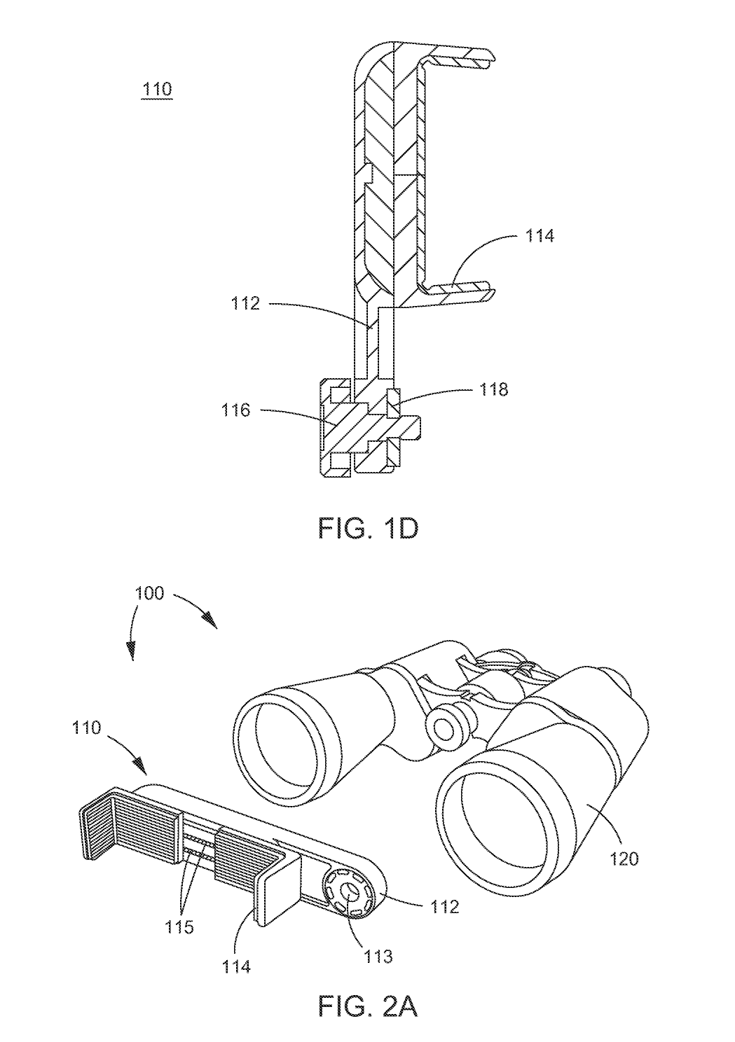

FIGS. 1A-1D illustrate a mounting device 110 for mounting and securing a smart phone to a pair of binoculars, according to an embodiment.

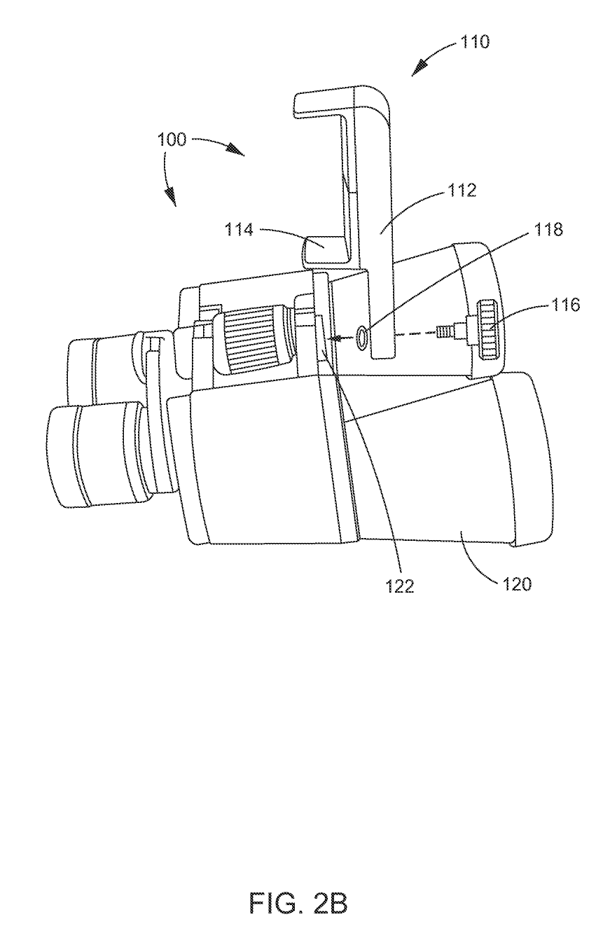

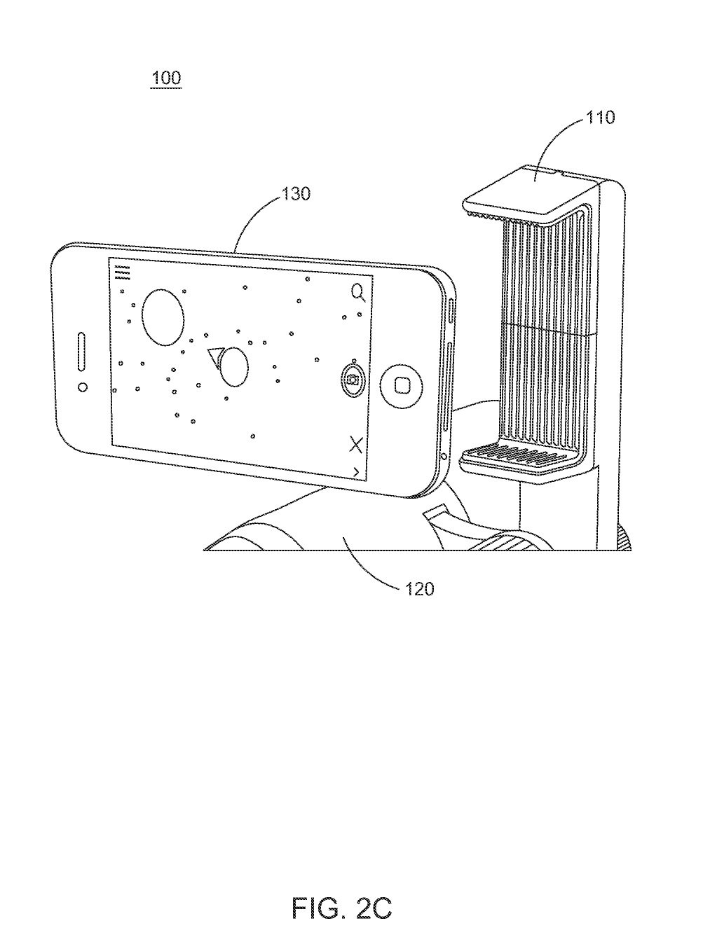

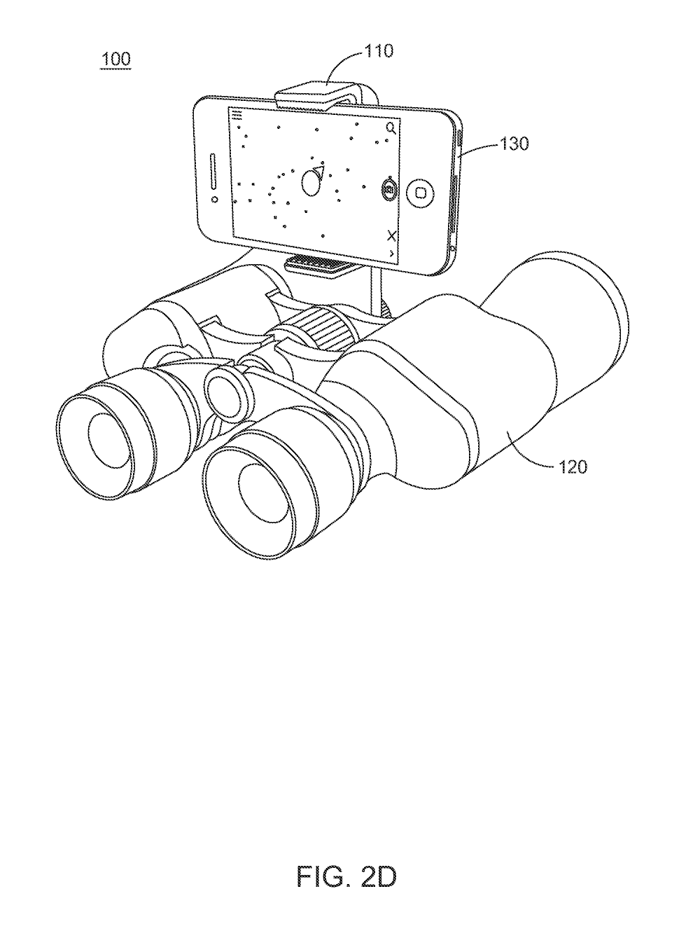

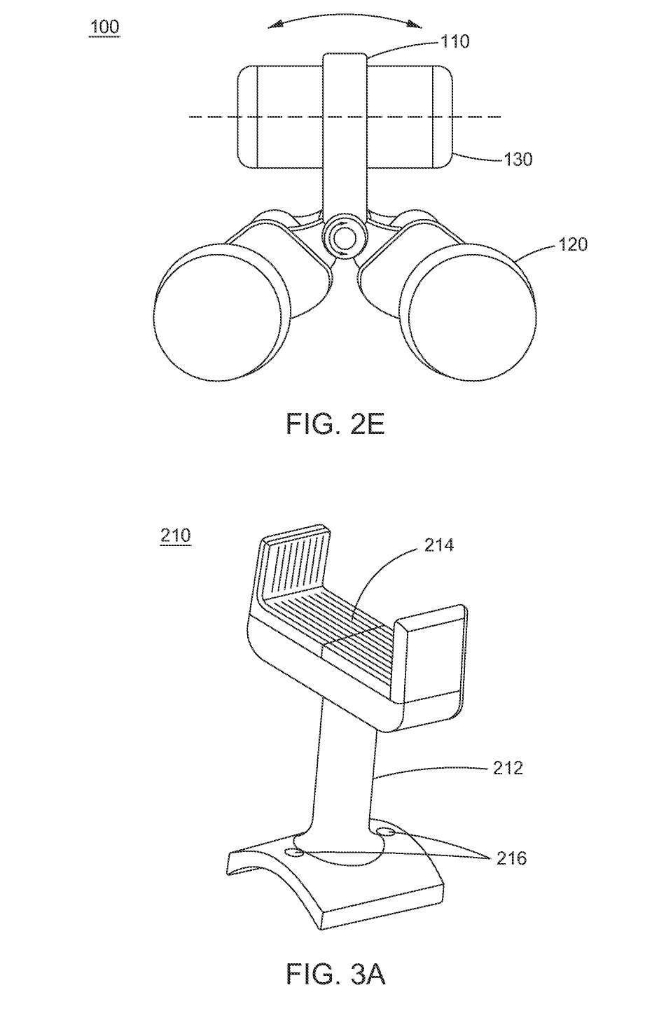

FIGS. 2A-2E illustrate an embodiment of a celestial viewing device 100 in which a mounting device 110 is provided on a pair of binoculars 120 for mounting and securing a smart phone 130 thereto.

As shown in FIGS. 1A-1D, a mounting device 110 includes a substantially vertically elongate base 112 to which an adjustable bracket 114 is secured at and extends along a top portion of the base 112. At a bottom portion of the base 112, a through-hole 113 is provided (see FIG. 2A) through which a mounting screw 116 fits. A mounting washer 118, through which the mounting screw 116 fits, may also be provided.

In an alternate embodiment, the bracket 114 may be oriented substantially perpendicular to the vertically elongate base 112.

As shown in FIGS. 1C, 1D, 2A, and 2C, the size of the bracket 114 is adjustable, allowing for the bracket 114 to expand and contract for placement of a smart phone 130 and/or to accommodate various-sized smart phones and other smart devices. The adjustability is achieved through, for example, one or more springs 115 positioned in the bracket 114. A cushioned contact area is, according to an embodiment, provided on the surfaces of the bracket 114 that may come into contact with the smart phone 130, thus preventing damage (e.g., scratches) to the smart phone 130.

As shown in FIGS. 2B-2E, the mounting device 110 is secured on a top portion or upper surface of a pair of binoculars 120, allowing a user to hold the binoculars 120 and look either through the view holes of the binoculars 120 or at a display portion of the smart phone 130 (see FIG. 2D).

As shown in FIGS. 2A and 2B, the mounting device 110 may be removably securable to the pair of binoculars 120. In one embodiment, the mounting device 110 is secured or otherwise connected to the binoculars 120 by threading of the mounting screw 116 through the through hole 113 and the mounting washer 118, and into a mounting screw socket 122 on the binoculars (see FIG. 2B).

In other embodiments, other means may be used to secure the mounting device 110 to the binoculars, such as a rivet and the like. In another embodiment, the mounting device 110 may be more rigidly secured (i.e., not removable) to the binoculars 120.

In some embodiments, the angle at which the bracket 114 is positioned with respect to the mounting device 110 and the pair of binoculars 120 may be adjustable, allowing for a user to move the bracket 114 and the smart phone 130 through various angles until it is positioned in a desirable manner for the user. For example, a user may reposition the smartphone in a perpendicular fashion with respect to the binoculars' eyepieces. This allows the user to adjust the binoculars' fit to the user's face without misaligning the application's guidance during operation. Once the bracket 114 and smart phone 130 are positioned at a desirable angle for the user (i.e., one in which the information shown on the screen of the smart phone 130 is aligned with the hardware's field of view and the user is able to clearly see the information displayed on the smart phone 130), the bracket 114 may, according to an embodiment, be locked into place. This adjustment and locking mechanism may be achieved through various means well known in the art. It is important to note that the mounting device 110 aligns the smartphone 130 and hardware (i.e., binoculars 120) together as one unit so that as a user rotates and tilts the binoculars 120, the field of view of the binoculars 120 focuses on the image/information shown on the screen of the smart phone 130.

FIG. 2E illustrates an adjustment of the mounting device 110 that may be done, according to an embodiment. The adjustment includes: placing the binoculars 120 on a flat surface, such as a table; inserting the smart phone 130 into the bracket 114 portion of the mounting device 110; slightly loosening the mounting screw 116; and tilting the mounting device 110 left and/or right to ensure it is straight and perpendicular to the binoculars 120. Once the mounting device 110 is properly oriented (i.e., essentially straight and perpendicular to the binoculars 120), the mounting screw 116 should be tightened. This adjustment ensures, or helps ensure, accuracy of the locating technology of the application installed on the smart phone 130 with the field of view of the binoculars 120.

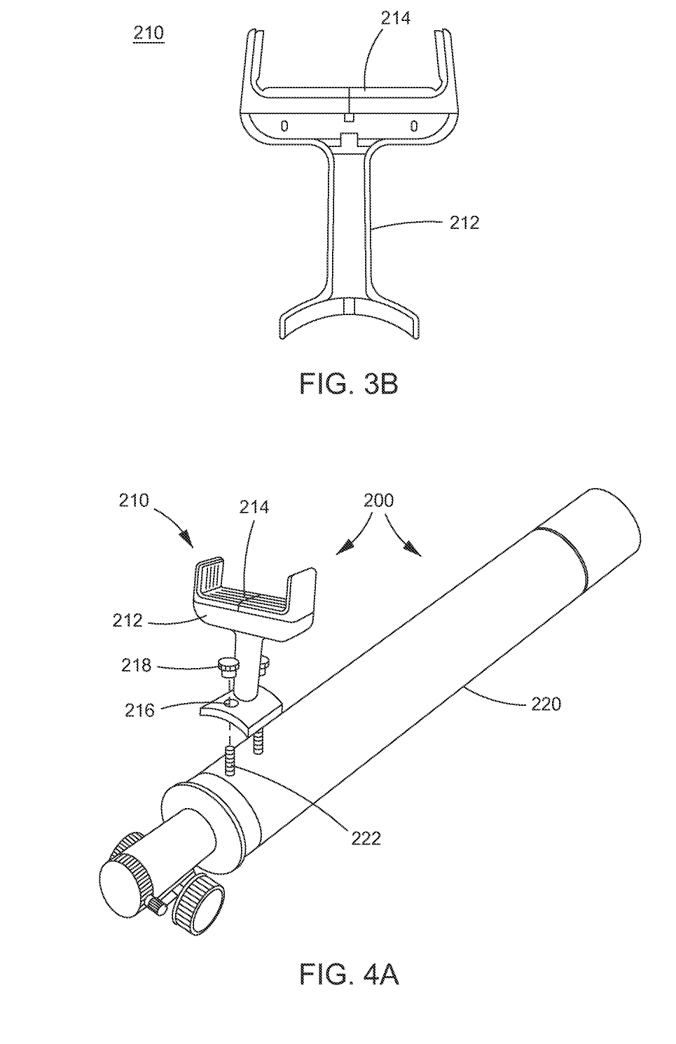

FIGS. 3A-3B illustrate a mounting device 210 for mounting and securing a smart phone to a telescope, according to an embodiment.

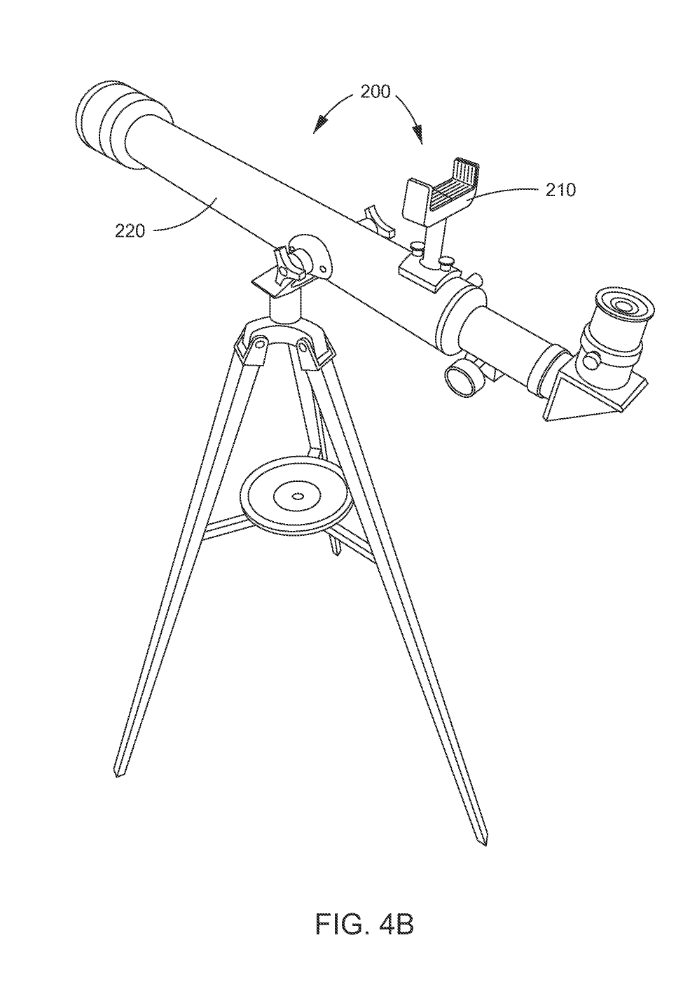

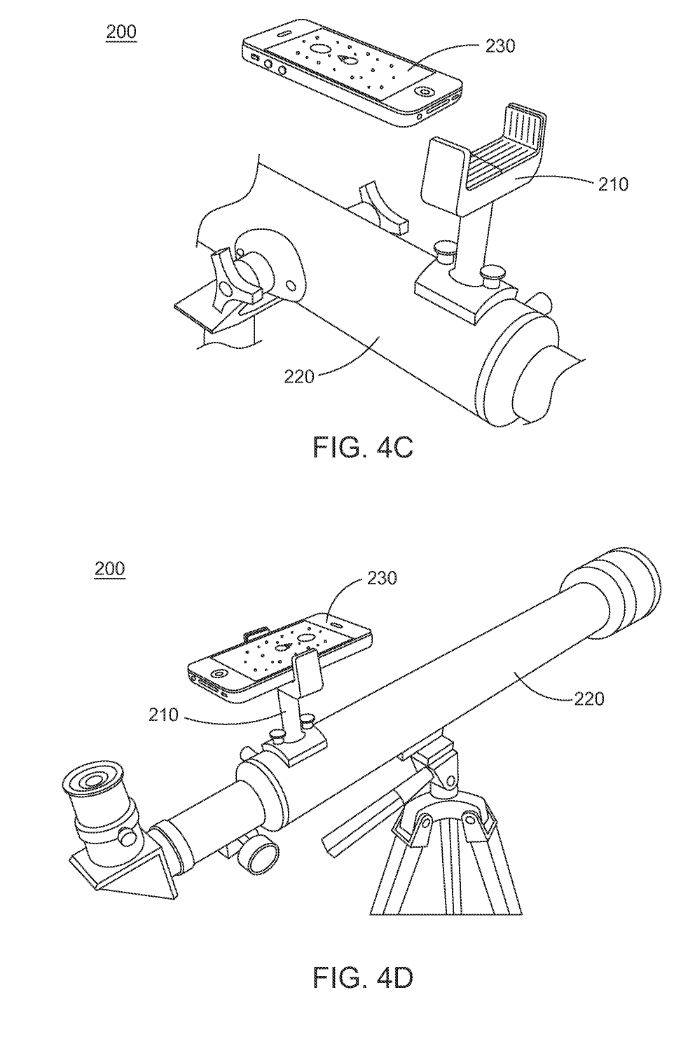

FIGS. 4A-4D illustrate an embodiment of a celestial viewing device 200 in which a mounting device 210 is provided on a telescope 220 for mounting and securing a smart phone 230 thereto.

The mounting device 210 for the telescope 220 functions in a manner similar to that described above with respect to the pair of binoculars.

As shown in FIGS. 3A and 3B, the mounting device 210 includes a base 212 at which an upper portion is secured an adjustable bracket 214. The bracket 214 is substantially perpendicular to a vertically elongate-extending portion of the base 212. At a bottom portion of the base 212 (e.g., on a longitudinally extending base portion), one or more through-holes 216 are provided (see FIG. 3A).

In an alternate embodiment, the bracket 214 may be oriented approximately 90 degrees from the orientation shown in FIGS. 3A and 3B, while still being substantially perpendicular to the vertically elongate-extending portion of the base 212.

The mounting device 210 is positioned on a top portion or upper surface of the telescope 220, allowing a user to hold the telescope 220 and look either through the view hole of the telescope or at a display portion of the smart phone 230 (see FIG. 4D). As shown in FIGS. 3B and 4A, the size of the bracket 214 is adjustable, allowing for the bracket 214 to expand and contract for placement of the smart phone 230 and/or to accommodate various-sized smart phones, and other smart devices. The adjustability is achieved through, for example, one or more springs positioned in the bracket 214. A cushioned contact area may be provided on the surfaces of the bracket 214 that may come into contact with the smart phone 230.

As shown in FIG. 4A, the mounting device 210 is removably securable to the telescope 220. In an embodiment, the telescope 220 includes one or more mounting screws 222 extending upright. The through-holes 216 of the mounting device 210 are placed onto corresponding ones of the mounting screws 222. Mounting screw caps 218 are provided to secure the mounting device 210 to the telescope 220 by twisting over corresponding ones of the mounting screws 222. The mounting device 210 may be removed by unscrewing the mounting screw caps 218 and lifting up the mounting device 210.

Other means may be used to secure the mounting device 210 to the telescope 220, such as a pair of rivets and the like. In another embodiment, the mounting device 210 may be more rigidly secured (i.e., not removable) to the telescope 220.

In some embodiments, the angle at which the bracket 214 is positioned may be adjustable, allowing for a user to move the bracket 214 and the smart phone 230 through various angles until it is positioned in a desirable manner for the user at which time the bracket 214 may be locked into place, as described above with respect to the binoculars 120. For example, in some binocular embodiments the mount is adjustable because adjusting the binoculars to fit your face also changes the angle of the mount. Once the binoculars fit your face, you then fine tune the angle of the binoculars mount to be perpendicular. In some telescope embodiments, the bracket is purposely not adjustable, so it aligns the field of view with the guidance of the smartphone app.

In some embodiments, the brackets 114, 214 may be sized and shaped to hold various tablet devices, such as, for example, a mini tablet or the like.

In some embodiments, the brackets 114, 214 may be rotatable around a pivot point connecting the bracket 114 or 214 to the base 112 or 212, thus allowing for a user to position the bracket 114, 214 in a desirable position for placement of the smart phone 130, 230.

In use, once the smart phone is mounted to the celestial viewing device via placement in the bracket, a celestial viewing application is run on the smart phone. In an embodiment, the SkyView® app is used. The application is configured to, based on global positioning data and interaction with a GPS receiver of the smart phone, locate various celestial objects in the sky. In one embodiment, once running on the smart phone, the application will identify nearby stars, satellites, planets, constellations, and the like, and will provide the user with a guide on the screen of the smart phone to locate the celestial objects with the viewing device. In another embodiment, a user may search for objects of interest, and the application will guide the user in locating the objects.

In other embodiments, other applications or types of applications running on a smart phone may be used in conjunction with the celestial viewing apparatus. For example, an application relating to flight paths may be utilized, allowing a user to view airplanes and receive associated information; an application for an air show (such as a hot air balloon show) may be provided, so that a user may watch the air show and be directed to items of interest; or, as another non-limiting example, an application for sporting events or concerts may be utilized, allowing a user to view aspects of the event or concert with more detailed information, if desired.

Although the present invention has been described with reference to exemplary embodiments, it is not limited thereto. Those skilled in the art will appreciate that numerous changes and modifications may be made to the preferred embodiments of the invention and that such changes and modifications may be made without departing from the true spirit of the invention. It is therefore intended that the appended claims be construed to cover all such equivalent variations as fall within the true spirit and scope of the invention.

We claim:

1. An apparatus for viewing celestial objects, the apparatus comprising:
a celestial viewing device; and
a mounting device comprising an adjustable bracket;
wherein the mounting device is adaptable to be mounted on a portion of the celestial viewing device, and wherein the bracket is configured to receive and support a smart phone.

2. The apparatus of claim 1, further comprising a mounting mechanism for securing the mounting device to the celestial viewing device, the mounting mechanism comprising one of (i) one or more mounting screws attachable to the mounting device and configured to fit into corresponding ones of mounting screw sockets formed on the celestial viewing device or (ii) one or more mounting screws on the celestial device configured to fit into corresponding ones of through-holes formed on the mounting device and be covered with corresponding ones of mounting screw caps.

3. The apparatus of claim 1, wherein the bracket is expandable and contractible to receive and securely support the smart phone.

4. The apparatus of claim 1, wherein the smart phone is configured to run an installed application that guides a user in locating celestial objects with the celestial viewing device.

5. The apparatus of claim 1, wherein an angle of the bracket with respect to the celestial viewing device synchronizes information from the smart phone, directing the user where to locate a targeted celestial object with a position of a field of view of the celestial viewing device.

6. The apparatus of claim 5, wherein the smart phone and the celestial viewing device are aligned such that as the celestial viewing device is rotated, the field of view of the celestial viewing device provides the user with a view provided on a screen of the smart phone.

7. The apparatus of claim 1, wherein the celestial viewing device comprises one of a telescope or a pair of binoculars.

8. The apparatus of claim 1, wherein the adjustable bracket comprises a cushioned contact area at which the smart phone is received and supported.

9. An apparatus for viewing celestial objects, the apparatus comprising:
a pair of binoculars; and
a mounting device comprising an adjustable bracket;
wherein the mounting device is adaptable to be mounted on an upper surface of the pair of binoculars, and wherein the bracket is configured to receive and support a smart phone.

10. The apparatus of claim 9, further comprising a mounting mechanism for securing the mounting device to the pair of binoculars, the mounting mechanism comprising one or more mounting screws attachable to the mounting device and configured to fit and thread into corresponding ones of mounting screw sockets formed on the pair of binoculars.

11. An apparatus for viewing celestial objects, the apparatus comprising:
a telescope; and
a mounting device comprising an adjustable bracket;
wherein the mounting device is adaptable to be mounted on an upper surface of the telescope, and wherein the bracket is configured to receive and support a smart phone.

12. The apparatus of claim 11, further comprising a mounting mechanism for securing the mounting device to the telescope, the mounting mechanism comprising one or more mounting screws on the telescope configured to fit into corresponding ones of through-holes formed on the mounting device, the mounting mechanism further comprising one or more mounting screw caps configured to screw onto corresponding ones of the one or more mounting screws.
